(19) United States
(12) Patent Application Publication
(10) Pub. No.: US 2026/0048647 A1
(43) Pub. Date: Feb. 19, 2026

(54) VEHICLE FRAME STRUCTURE

(71) Applicant: FORD GLOBAL TECHNOLOGIES, LLC, Dearborn, MI (US)

(72) Inventors: Mary A. MASON, Dearborn, MI (US); Sankarsh Kanth AEKBOTE VISHNUKANTH, Farmington, MI (US); Leonard Anthony SHANER, New Baltimore, MI (US); Greg GOMBERT, Canton, MI (US); Diego Eduardo MENDOZA HERNANDEZ, Pueblo Nuevo (MX); Krishnakanth E. AEKBOTE, Novi, MI (US); Mark Andrew COLDREN, Westland, MI (US); Dale Walter GEHRINGER, JR., Brownstown Twp, MI (US); Mikolaj TYKSINSKI, Madison, WI (US)

(21) Appl. No.: 18/808,476

(22) Filed: Aug. 19, 2024

(51) Int. Cl. B60K 1/04; B62D 21/02; B62D 21/15

(52) U.S. Cl. CPC B60K 1/04; B62D 21/02; B62D 21/15; B60K 2001/0438

(57) ABSTRACT

A vehicle includes a frame, a battery, and blockers. The frame has rails defining a space therebetween. The battery is disposed within the space. The battery is secured to the frame via a floating connection. The battery is configured to store and provide electrical power to propel the vehicle. The blockers protrude inward from the rails and into the space. The blockers are disposed along an edge of the battery. The blockers are spaced-apart from the edge of the battery. The blockers are operable to engage the edge of the battery to limit forward movement of the battery in response to deformation of the frame. The floating connection facilitates limited movement of the battery within the space such that the battery is movable toward the blockers but is prevented from contacting the blockers while the frame is in a non-deformed state.

### TECHNICAL FIELD

The present disclosure relates to vehicle body structures and/or vehicle frame structures.

### BACKGROUND

Vehicles and automobiles include bodies and/or frames that operate as the underlying support structure for the other subsystems of the vehicle (e.g., powertrain systems, steering systems, etc.).

### SUMMARY

A vehicle includes a frame, a battery, and blockers. The frame has rails defining a space therebetween. The battery is disposed within the space. The battery is secured to the frame via a floating connection. The battery is configured to store and provide electrical power to propel the vehicle. The blockers protrude inward from the rails and into the space. The blockers are disposed along an edge of the battery. The blockers are spaced-apart from the edge of the battery. The blockers are operable to engage the edge of the battery to limit forward movement of the battery in response to deformation of the frame or the floating connection extending beyond an operable range of motion. The floating connection facilitates limited movement of the battery within the space such that the battery is movable toward the blockers but is prevented from contacting the blockers while the frame is in a non-deformed state and the floating connection remains within the operable range of motion.

A vehicle includes a frame, a battery, a first blocker, and a second blocker. The frame defines a central space. The battery is disposed within the central space and is secured to the frame. The first and second blockers protrude from the frame and into the central space. The first and second blockers extend over opposing ends of a forward edge of the battery. The first and second blockers are operable to engage the forward edge of the battery to limit forward movement of the battery in response to deformation of the frame.

A vehicle includes a frame, a cradle, a traction battery, a first blocker, and a second blocker. The frame has first and second side rails extending longitudinally between forward and rearward regions of the vehicle. The first and second side rails define a space therebetween. The cradle is secured to the first and second sides rails and extends between the first and second rails within the space. The traction battery is disposed within the space such that first and second gaps are defined between the traction battery and the first and second rails, respectively. The traction battery is secured to the cradle via a floating connection. The traction battery is configured to store and provide electrical power to propel the vehicle. The first and second blockers protrude inward from the first and second side rails and into the space, respectively. The first and second blockers are disposed along a front edge of the traction battery. The first and second blockers are spaced-apart from the front edge of the traction battery such that third and fourth gaps are defined between the traction battery and the first and second blockers, respectively. The first and second blockers are operable to engage the front edge of the battery to limit forward movement of the traction battery in response to deformation of the frame or the floating connection extending beyond an operable range of motion. The floating connection facilitates limited movement of the traction battery laterally between the first and second side rails such that the traction battery is movable within the first and second gaps but is prevented from contacting the first and second side rails while the frame is in a non-deformed state and the floating connection remains within the operable range of motion. The floating connection further facilitates limited movement of the traction battery longitudinally between the forward and rearward regions of the vehicle such that the traction battery is movable within the third and fourth gaps but is prevented from contacting the first and second blockers while the frame is in a non-deformed state and the floating connection remains within the operable range of motion.

### BRIEF DESCRIPTION OF THE DRAWINGS

FIG. 1 is a perspective top view of a portion of a vehicle including a portion of a vehicle frame that includes a front region of the vehicle frame;

FIG. 2 is a top view of the portion of the vehicle including the portion of the vehicle frame that includes the front region of the vehicle frame, illustrating the vehicle frame in a non-deformed state;

FIG. 3 is a top view of the portion of the vehicle including the portion of the vehicle frame that includes the front region of the vehicle frame, illustrating the vehicle frame in a deformed state;

FIG. 4 is a bottom view of the vehicle frame illustrating a cradle that is operable to secure a traction battery to the vehicle frame;

FIG. 5 is a cross-sectional view taken along line 5-5 in FIG. 2.

FIG. 6 is a cross-sectional view taken along line 6-6 in FIG. 2.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

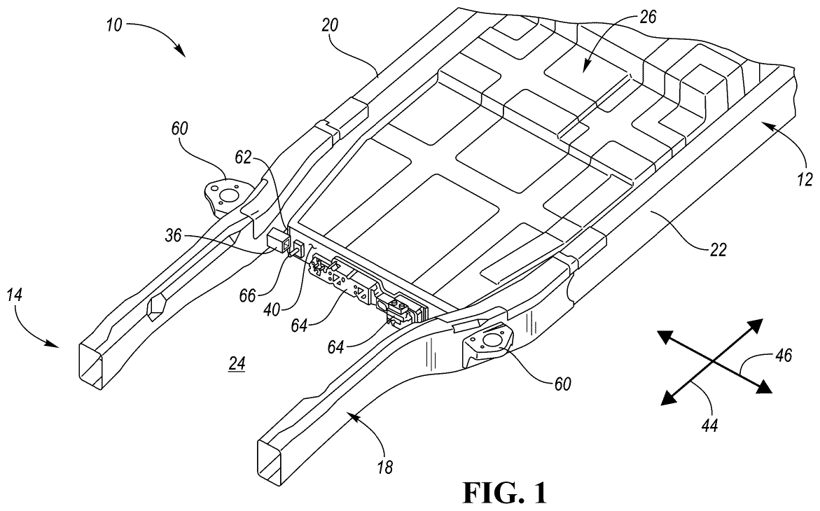

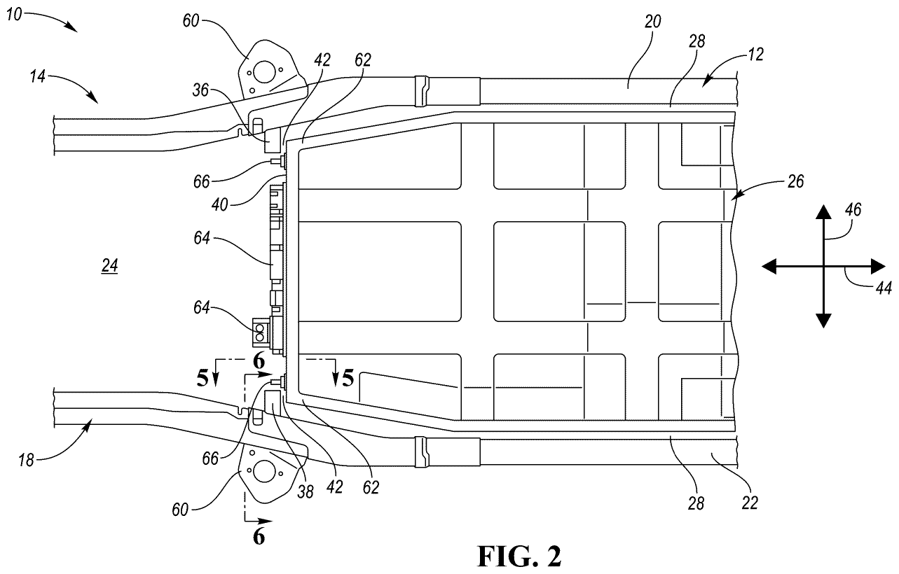

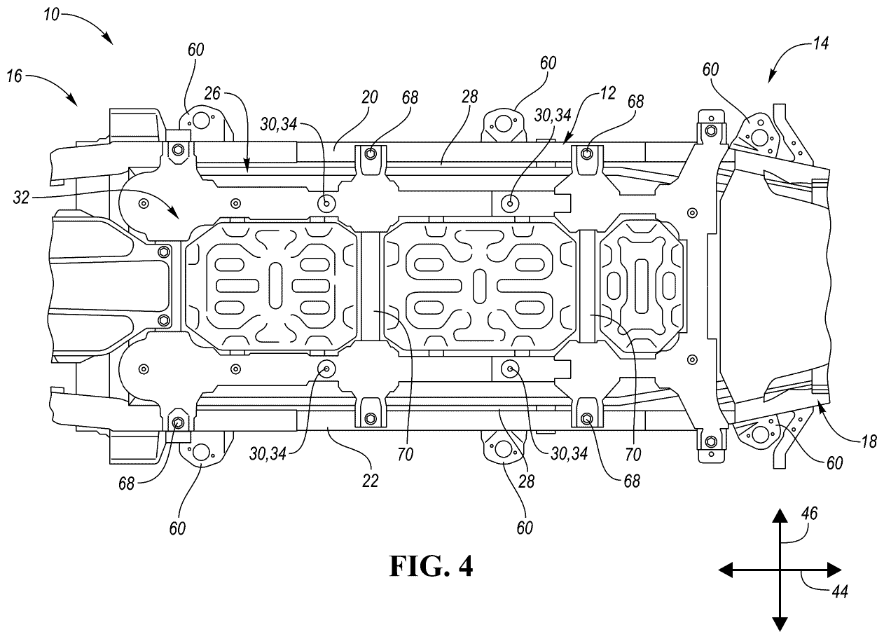

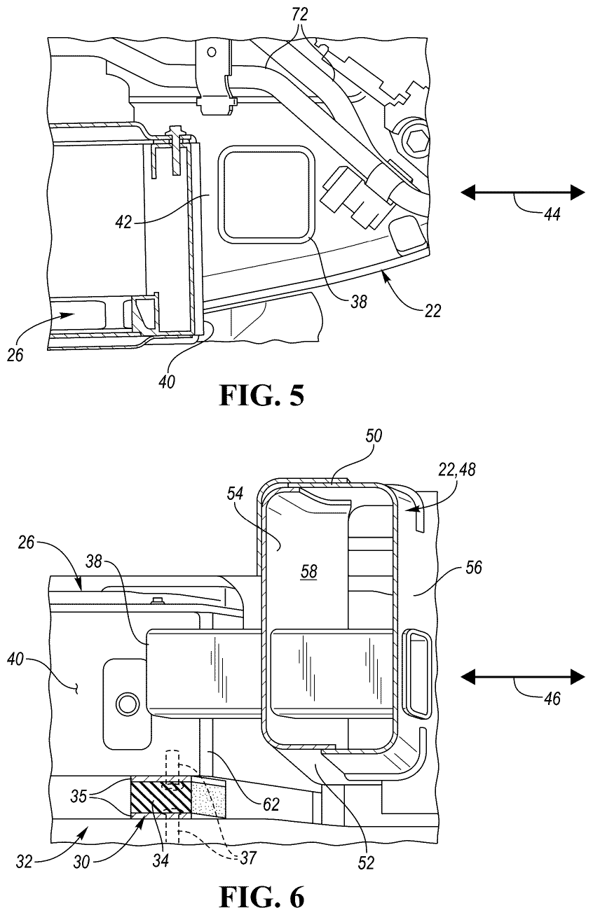

Referring to FIGS. 1-6, a portion of a vehicle 10 including a portion of a vehicle frame 12 is illustrated. The vehicle 10 includes forward region 14 and a rearward region 16. The vehicle frame 12 includes a front region 18 positioned along the forward region 14 of the vehicle 10. The frame 12 has a first side rail 20 and a second side rail 22 extending longitudinally between forward region 14 and a rearward region 16 of the vehicle 10. The first side rail 20 and the second side rail 22 define a central space, or more generally a space 24 therebetween. The frame 12 may, more generally, define the space 24.

A battery 26 is disposed within the space 24 such that gaps 28 are defined between the battery 26 and the first and second side rails 20, 22. More specifically, a first of the gaps 28 may be defined between the battery 26 and the first side rail 20 while a second of the gaps 28 is defined between the battery 26 and the second side rail 22. The battery 26 is secured to the frame 12, or more specifically to the first side rail 20 and the second side rail 22, via a floating connection 30. The battery 26 may be a traction battery that is configured to store and provide electrical power to propel the vehicle 10. A cradle 32 may be secured to the frame 12, or more specifically to the first side rail 20 and the second side rail 22. The cradle 32 extends between the first side rail 20 and the second side rail 22 within the space 24. The cradle 32 also extends between the forward region 14 of the vehicle 10 and the rearward region 16 of the vehicle 10 within the space 24.

The battery 26 may be directly secured to the cradle 32 via the floating connection 30 and indirectly secured to the frame 12, or more specifically to the first side rail 20 and the second side rail 22, via the cradle 32 and the floating connection 30. The floating connection 30 may comprise a plurality of resilient blocks 34 connecting the battery 26 to the cradle 32. The resilient blocks may be made from a resilient material, such as rubber, that facilitates limited movement of the battery 26 relative to the cradle 32.

A first blocker 36 and a second blocker 38 protrude inward from the first side rail 20 and the second side rail 22, respectively, and into the space 24. More generally, the first blocker 36 and the second blocker 38 protrude into the space 24 from the frame 12. The first blocker 36 and the second blocker 38 may be tubular. The first blocker 36 and the second blocker 38 are disposed along an edge of the battery 26. More specifically, the edge of the battery 26 may be a forward edge or front edge 40 of the battery 26. The first blocker 36 and the second blocker 38 may overhang opposing ends or opposing sides of the front edge 40 of the battery 26. The first blocker 36 and the second blocker 38 may also be spaced-apart from the front edge 40 of the battery 26 such that gaps 42 are defined between the battery 26 and the first blocker 36, and between battery 26 and the second blocker 38. More specifically, a first of the gaps 42 may be defined between the battery 26 and the first blocker 36 along the front edge 40 of the battery 26 while a second of the gaps 42 may be defined between the battery 26 and the second blocker 38 along the front edge 40 of the battery 26. Gaps 42 may be referred to as the third and fourth gaps while gaps 28 may be referred to as the first and second gaps, or vice versa.

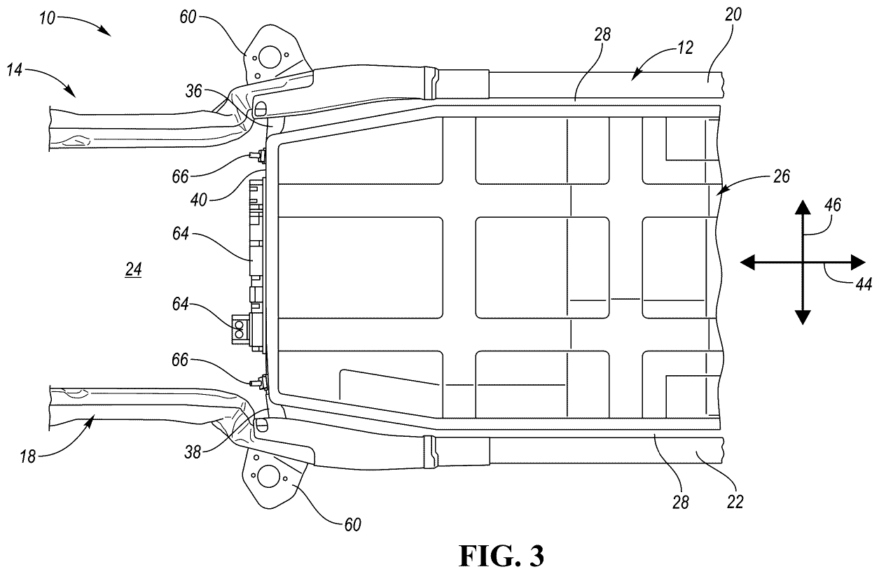

The first blocker 36 and the second blocker 38 are operable to engage the front edge 40 of the battery 26 to limit forward movement of the battery 26 (e.g., movement in direction 44 from the rearward region 16 toward the forward region 14 of the vehicle 10) in response to deformation of the frame 12, fracture of the frame 12, deformation of the floating connection 30, or fracture of the floating connection 30. Such deformation of or fracture of the frame 12 may include deformation or fracture of the first side rail 20, the second side rail 22, or the battery 26 itself (e.g., see FIG. 3). Such deformation of the floating connection 30 or fracture of the floating connection 30 may include deformation of or fracture of the resilient blocks 34, base plates 35 of the floating connection 30, or fastening portions 37 of the floating connection 30. The floating connection 30 facilitates limited movement of the battery 26 laterally between the first side rail 20 and the second side rail 22 along direction 46 such that the battery 26 is movable within the gaps 28 but is prevented from contacting the first side rail 20 and the second side rail 22 while the frame 12 is in a non-deformed state (e.g., see FIG. 1) and while the floating connection 30 remains within the operable range of motion. The floating connection 30 also facilitates limited movement of the battery 26 longitudinally (e.g., movement in direction 44 between the forward region 14 of the vehicle 10 and the rearward region 16 of the vehicle 10) such that the battery 26 is movable within the gaps 42 toward the first blocker 36 and the second blocker 38 but is prevented from contacting the first blocker 36 and the second blocker 38 while the frame 12 is in a non-deformed state and while the floating connection 30 remains within the operable range of motion.

The operable range of motion of the floating connection 30 may correspond to the floating connection 30 operating or moving within an elastic range where the floating connection 30 and/or the resilient blocks 34 do not experience plastic deformation. The floating connection 30 extending beyond an operable range of motion may correspond to the floating connection 30 and/or the resilient blocks 34 experiencing plastic deformation or fracture.

Direction 44 may be substantially perpendicular to direction 46. As used herein, substantially perpendicular refers to any incremental angle that is between exactly perpendicular and 15°or less from exactly perpendicular (e.g., 12.5°or less from exactly perpendicular, 10°or less from exactly perpendicular, 5°or less from exactly perpendicular, 1°or less from exactly perpendicular, 0.5°or less from exactly perpendicular, 0.1°or less from exactly perpendicular, etc.).

The first side rail 20 and the second side rail 22 comprise first and second structural tubes 48, respectively. The structural tubes 48 each have an upper wall 50, a lower wall 52, a first lateral wall 54, and a second lateral wall 56 defining a cavity 58 therebetween. The first blocker 36 and the second blocker 38 are secured to the first and second lateral walls 54, 56 and extend through the cavities 58 defined by the first and second structural tubes 48, respectively.

The vehicle 10 may further include a plurality of mounting brackets 60 operable for securing a vehicle body structure to the frame 12. A first and a second of the mounting brackets 60 are secured to laterally outward sides of the first side rail 20 and the second side rail 22, respectively. The first and the second of the mounting brackets 60 are disposed on opposing sides of the first side rail 20 and the second side rail 22 relative to the first blocker 36 and the second blocker 38, respectively. The first and the second of the mounting brackets 60 are aligned with the first blocker 36 and the second blocker 38 longitudinally (e.g., along direction 44) between the forward region 14 of the vehicle 10 and the rearward region 16 of the vehicle 10, respectively.

The battery 26 includes side walls 62; electrical connectors 64 protruding from the front edge 40 of the battery 26 between the side walls 62; and coolant inlets, outlets, conduits 66 (e.g., tubes, pipes, etc.) protruding from the front edge 40 of the battery 26 between the side walls 62. The first blocker 36 and the second blocker 38 extend laterally over the front edge 40 of the battery 26 such that each of the first blocker 36 and the second blocker 38 overhang one of the side walls 62 but not the electrical connectors 64. The first blocker 36 and the second blocker 38 also extend laterally over the front edge 40 of the battery 26 such that each of the first blocker 36 and the second blocker 38 overhang one of the side walls 62 but not the conduits 66.

Frontal impacts on a rigid barrier may result in high residual inertia of isolated or rigidly mounted components like a large high-voltage traction battery on an electric vehicle. Therefore, such batteries need to be contained to prevent unwanted contact with components surrounding the battery, particularly along the front or rear the battery. The first blocker 36 and the second blocker 38 disclosed herein, operate precisely to contain the battery 26 during such impacts in order to prevent contact between the battery 26 and the surrounding components of the vehicle 10.

The frame 12 (including the first side rail 20, the second side rail 22, the first blocker 36, and the second blocker 38) are located at a predetermined distance from the battery 26 to allow for the battery 26 to be isolated from road loads during normal operation. Therefore, the gaps 42 between the blockers (i.e., the first blocker 36 and the second blocker 38) and the battery 26 are set to such a predetermined distance so that the battery 26 does not contact the blockers during normal operation of the vehicle 10 while the frame 12 remains in the non-deformed state. The size of the bolts 68 securing the cradle 32 to the frame 12 (or more specially to the first side rail 20 and the second side rail 22) should be minimized to allow for smaller rubber isolated mounts (e.g., the resilient blocks 34 of the floating connection 30) and smaller battery cross-members 70 on the cradle 32.

The blockers (i.e., the first blocker 36 and the second blocker 38) have a limited footprint on the frame rails (i.e., the first side rail 20 and the second side rail 22) so that the blockers do not interfere with the necessary frame crush at the front of the vehicle during an impact while also reducing battery inertial loading.

The blockers (i.e., the first blocker 36 and the second blocker 38) are placed within the footprint of the body mount brackets (i.e., mounting brackets 60) to ensure the blockers have no significant effect on the total vehicle crush needed for pulse management. The blockers are also located at a predetermined distance forward of the battery 26, which allows for normal movement and isolation of the battery 26 from the frame 12 (including the first side rail 20, the second side rail 22, the first blocker 36, and the second blocker 38) under normal elastic road-driving conditions. In an impact scenario where deformation exceeds the predetermined distance due to plastic deformation, the frame blockers (i.e., the first blocker 36 and the second blocker 38) engage with the battery 26, thereby reducing loading on the bolts (e.g., bolts 68 securing the cradle 32 to the frame 12) and preventing fracture or deformation of the bolts. In the case of fracture or deformation of the bolts (e.g., bolts 68 securing the cradle 32 to the frame 12), the blockers (i.e., the first blocker 36 and the second blocker 38) also serve to prevent the battery 26 from moving forward into surrounding components.

The blockers (i.e., the first blocker 36 and the second blocker 38) are aligned with body mount brackets (i.e., mounting brackets 60), which also operate as reinforcements for the frame 12. Therefore, the blockers (i.e., the first blocker 36 and the second blocker 38) do not interfere with the natural crush of the frame 12, which is required for reducing inertial battery loading. The blockers may be through-welded to utilize the inboard and outboard frame rail stampings for additional rigidity (e.g., the first blocker 36 and the second blocker 38 may each be welded to a first lateral wall 54 and a second lateral wall 56 of a corresponding structural tube 48). The blockers (i.e., the first blocker 36 and the second blocker 38) may also be positioned to prevent interference with other components routed along the frame 12 such as coolant conduits 72.

In FIG. 3, the blockers (i.e., the first blocker 36 and the second blocker 38) and battery 26 are illustrated after of the full-frontal impact event. The battery 26 has been effectively retained within the frame 12. The blockers are shown to engage the side walls 62 of the battery 26 but do not engage with the high-voltage connectors (e.g., electrical connectors 64) or coolant inlets (e.g., conduits 66).

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A vehicle comprising:
a frame having rails defining a space therebetween;
a battery disposed within the space, secured to the frame via a floating connection, and configured to store and provide electrical power to propel the vehicle; and
blockers protruding inward from the rails and into the space, disposed along an edge of the battery, spaced-apart from the edge of the battery, and operable to engage the edge of the battery to limit forward movement of the battery in response to deformation of the frame or the floating connection extending beyond an operable range of motion, wherein the floating connection facilitates limited movement of the battery within the space such that the battery is movable toward the blockers but is prevented from contacting the blockers while the frame is in a non-deformed state and the floating connection remains within the operable range of motion.

2. The vehicle of claim 1, wherein each rail comprises a structural tube having an upper wall, a lower wall, a first lateral wall, and a second lateral wall defining a cavity therebetween, and wherein each blocker is secured to the first and second lateral walls and extends through the cavity defined by one of the structural tubes.

3. The vehicle of claim 1 further comprising mounting brackets operable for securing a vehicle body structure to the frame, wherein each mounting bracket is secured to a laterally outward side of one of the rails, is disposed on an opposing side of the corresponding rail relative to one of the blockers, and is aligned with the corresponding blocker longitudinally between forward and rearward regions of the vehicle.

4. The vehicle of claim 1, wherein the battery includes side walls and electrical connectors protruding from the edge of the battery between the side walls, and wherein the blockers extend over the edge of the battery such that the blockers overhang the side walls but not the electrical connectors.

5. The vehicle of claim 1, wherein the battery includes side walls and coolant conduits protruding from the edge of the battery between the side walls, and wherein the blockers extend over the edge of the battery such that the blockers overhang the side walls but not the coolant conduits.

6. The vehicle of claim 1 further comprising a cradle that secures the battery to the frame.

7. The vehicle of claim 6, wherein the floating connection includes resilient blocks connecting the battery to the cradle.

8. A vehicle comprising:
a frame defining a central space;
a battery disposed within the central space and secured to the frame; and
first and second blockers protruding from the frame and into the central space, extending over opposing ends of a forward edge of the battery, and operable to engage the forward edge of the battery to limit forward movement of the battery in response to deformation of the frame.

9. The vehicle of claim 8, wherein the frame comprises structural tubes each having an upper wall, a lower wall, a first lateral wall, and a second lateral wall defining a cavity therebetween, and wherein each of the first and second blockers is secured to the first and second lateral walls and extends through the cavity defined by one of the structural tubes.

10. The vehicle of claim 9 further comprising mounting brackets operable for securing a vehicle body structure to the frame, wherein each mounting bracket is secured to a laterally outward side of one of the structural tubes, is disposed on an opposing side of the corresponding structural tube relative to one of the first and second blockers, and is aligned with one of the first and second blockers longitudinally between forward and rearward regions of the vehicle.

11. The vehicle of claim 8, wherein the battery includes side walls and electrical connectors protruding from the forward edge of the battery between the side walls, and wherein the first and second blockers extend over the forward edge of the battery such that each of the blockers overhang one of the side walls but not the electrical connectors.

12. The vehicle of claim 8, wherein the battery includes side walls and coolant conduits protruding from the forward edge of the battery between the side walls, and wherein the first and second blockers extend over the forward edge of the battery such that each of the blockers overhang one of the side walls but not the coolant conduits.

13. The vehicle of claim 8, wherein the battery is secured to the frame via a floating connection.

14. The vehicle of claim 13, wherein the floating connection facilitates limited movement of the battery within the space such that the battery is movable toward the first and second blockers but is prevented from contacting the first and second blockers while the frame is in a non-deformed state and the floating connection remains within an operable range of motion.

15. A vehicle comprising:
a frame having first and second side rails (i) extending longitudinally between forward and rearward regions of the vehicle and (ii) defining a space therebetween;
a cradle secured to the first and second sides rails and extending between the first and second rails within the space;
a traction battery (i) disposed within the space such that first and second gaps are defined between the traction battery and the first and second rails, respectively, (ii) secured to the cradle via a floating connection, and (iii) configured to store and provide electrical power to propel the vehicle; and
first and second blockers (i) protruding inward from the first and second side rails and into the space, respectively, (ii) disposed along a front edge of the traction battery, (iii) spaced-apart from the front edge of the traction battery such that third and fourth gaps are defined between the traction battery and the first and second blockers, respectively, and (iv) operable to engage the front edge of the battery to limit forward movement of the traction battery in response to deformation of the frame or the floating connection extending beyond an operable range of motion, wherein the floating connection facilitates limited movement of the traction battery (a) laterally between the first and second side rails such that the traction battery is movable within the first and second gaps but is prevented from contacting the first and second side rails while the frame is in a non-deformed state and the floating connection remains within the operable range of motion and (b) longitudinally between the forward and rearward regions of the vehicle such that the traction battery is movable within the third and fourth gaps but is prevented from contacting the first and second blockers while the frame is in a non-deformed state and the floating connection remains within the operable range of motion.

16. The vehicle of claim 15, wherein the first and second side rails comprise first and second structural tubes each having an upper wall, a lower wall, a first lateral wall, and a second lateral wall defining a cavity therebetween, and wherein first and second blockers are secured to the first and second lateral walls and extend through the cavities defined by the first and second structural tubes, respectively.

17. The vehicle of claim 15 further comprising first and second mounting brackets operable for securing a vehicle body structure to the frame, wherein the first and second mounting brackets are secured to laterally outward sides of the first and second rails, respectively, are disposed on opposing sides of the first and second rails relative to the first and second blockers, respectively, and are aligned with the first and second blockers longitudinally between the forward and rearward regions of the vehicle, respectively.

18. The vehicle of claim 15, wherein the battery includes side walls and electrical connectors protruding from the front edge of the battery between the side walls, and wherein the first and second blockers extend over the front edge of the battery such that each of the blockers overhang one of the side walls but not the electrical connectors.

19. The vehicle of claim 15, wherein the battery includes side walls and coolant conduits protruding from the front edge of the battery between the side walls, and wherein the first and second blockers extend over the front edge of the battery such that each of the blockers overhang one of the side walls but not the coolant conduits.

20. The vehicle of claim 15, wherein the floating connection includes resilient blocks.
